(19) United States
(12) Patent Application Publication
(10) Pub. No.: US 2003/0133393 A1
(43) Pub. Date: Jul. 17, 2003

(54) Recording and reading method of an optical disk

(76) Inventor: Katsuhiko Shinohara, Kakogawa-shi (JP)

Correspondence Address: Katsuhiko Shinohara, 669-20, Kimura, Kakogawa-choo, Kakogawa-Shi, 675-0038, JP

(21) Appl. No.: 10/118,208

(22) Filed: Apr. 9, 2002

(30) Foreign Application Priority Data
Jan. 15, 2002 (JP) 2002-58042
Jan. 21, 2002 (JP) 2002-62709

(51) Int. Cl. G11B 7/135; G11B 7/125

(52) U.S. Cl. 369/112.17; 369/121; 369/111

(57) ABSTRACT

Two standard marks are set on two adjacent respective recording tracks, aligned in a direction perpendicular to the said recording tracks in the unit area for recording and reading that includes said the two recording tracks. Recording on the recording track is performed by forming round-marks that have information shown by which side of the two tracks they exist in and by what distance they are from each of the said two standard marks in the set area including the said two recording tracks. Reading information on the recording track is performed by reading two recording tracks at the same time or alternately.

### BACKGROUND OF THE INVENTION

The present invention relates to a recording and reading method for an optical disk.

The conventional recording and reading method of an optical disk arranges recording information using the distance between recorded marks in the direction of a recording track. This has the problem that it cannot cope with recording and reading relatively large masses of information, required in modern society.

1) Number; 350304, Country; Japan

Day/Month/Year Field; 30/September/2000

2)R. Juskaitis and T. Wilson:APPLIED OPTICS/Vol.31,No.7/March 1992.pp898˜900

The above two prior arts could not provide a recording and reading method for an optical disk that can record a larger mass of information on the optical disk.

### SUMMARY OF THE INVENTION

The objective of the present invention is to provide a recording and reading method for an optical disk that can record a larger mass of information on an optical disk and can read at high speed. In order to achieve these objectives, said present invention places recording information, represented by the placement of the recording marks, in a set area, which may include several recording tracks.

### BRIEF DESCRIPTION OF THE DRAWING

FIG. 1 shows the block diagram of an embodiment.

FIG. 2 shows the diagram of the photo detector surfaces.

FIG. 3 shows the graph for calculating the photo-detecting quantity from a light point on the optical disk.

FIG. 4 shows the graph for calculating the photo-detecting quantity from more than two light points on the optical disk.

FIG. 5 shows the graph of the change in photo-detecting quantity of a recorded round-mark on the optical disk.

FIG. 6 shows the front arrangement view of the photo-detector surfaces and the linear slits just before them.

FIG. 7 shows a second front arrangement view of the photo-detector surfaces and the linear slits just before them.

FIG. 8 shows the graph of the change in the applied voltage to the light deflectors exploiting the electro-optical effect.

FIG. 9 shows the graph of a unit for recording and reading that includes two recording tracks and two standard marks.

FIG. 10 shows the arrangement relationship between the recorded round-marks in the set recording area on two recording tracks and the standard marks in it.

FIG. 11 shows the arrangement relationship between the recorded round-marks in the set recording area on two recording tracks and the standard marks in it.

FIG. 12 shows the arrangement relationship between the recorded round-marks in the set recording area on two recording tracks and the standard marks in it.

FIG. 13 shows the arrangement relationship between the recorded round-marks in the set recording area on two recording tracks and the standard marks in it.

FIG. 14 shows the arrangement relationship between the recorded round-marks in the set recording area on two recording tracks and the standard marks in it.

FIG. 15 shows the arrangement relationship between the recorded round-marks in the set recording area on two recording tracks and the standard marks in it.

FIG. 16 shows the arrangement relationship between the recorded marks on a recording track using the mark-edge method.

FIG. 17 shows the block diagram of another embodiment.

### DESCRIPTION OF THE PREFERRED EMBODIMENTS

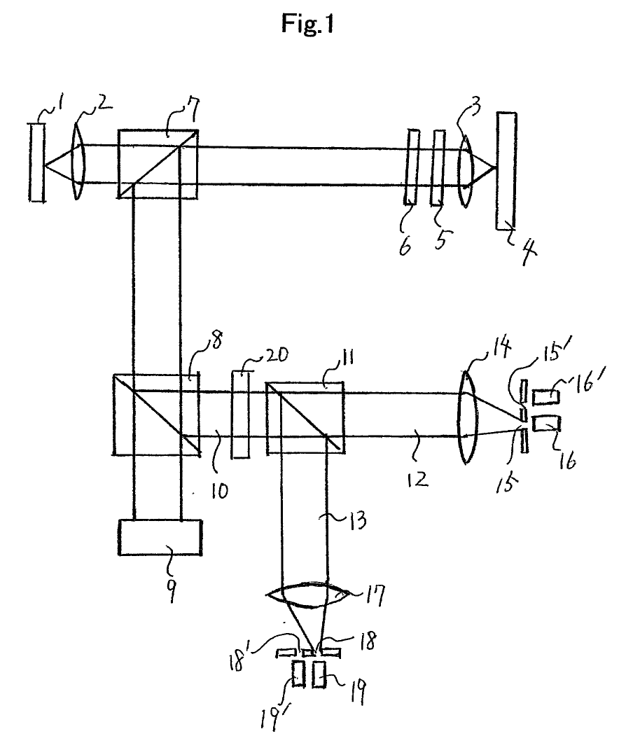

An embodiment of the present invention is explained hereinafter referring to Figures. In FIG. 1, the laser beam emitted by a semiconductor laser source 1 is turned into parallel light using a coupling lens 2, and is focused on an optional disk 4 by an objective 3.

The focus spot of this recording light beam is deflected to two adjacent recording tracks in the set area by a tracking light deflector 5. The then-said focus spot is vertical-vibration scanned between the two adjacent recording tracks by a light deflector 6 utilizing the electro-optical effect.

In this operation, recording is performed first by forming two standard marks, aligned on two adjacent recording tracks in a direction perpendicular to the recording track. Recording is preformed by forming round-marks that represent information according to which side of the two tracks they exist in or are absent from and by what distance they are from the previously mentioned two standard marks in the set area including the two said recording tracks.

When the recorded information on said optical disk 4 is read, said reading light beam is vertical-vibration scanned between the two adjacent recording tracks with a light deflector 6 utilizing the electro-optical-effect.

The returned light beam from said optical disk 4 is separated by a polarization beam splitter 7, positioned between said coupling lens 2 and said objective 3 on the optical path, and is then split into two light beams by a polarization beam splitter 8. One light polarization beam is guided to a device for tracking 9. The other light beam 10 is divided into light beam 12 and 13 by a beam splitter 11. Said light beam 12 is detected by a photo detector 16 through an objective 14 and a linear slit 15. Said light beam 13 is detected by a photo detector 19 through an objective 17 and a linear slit 18. These said linear slits 15, and 18 are set closely at inner and outer positions respectively of the focuses of said objective 14, and 17.

The then said light beam 10 is high-frequency-vibration scanned by a light detector 20 installed between said polarization beam splitter 8 and 11, which utilizes the electro-optical effect and is synchronized with said light deflector 6. Said light beam 12 is therefore deflected by said light deflector 20 and then detected by a photo detector 16′ through a linear slit 15′.

Said light beam 13 is also deflected by said light deflector 20 and then is detected by a photo detector 19′ through a linear slit 18′. It is therefore possible to independently detect recorded marks on each of the two recording tracks.

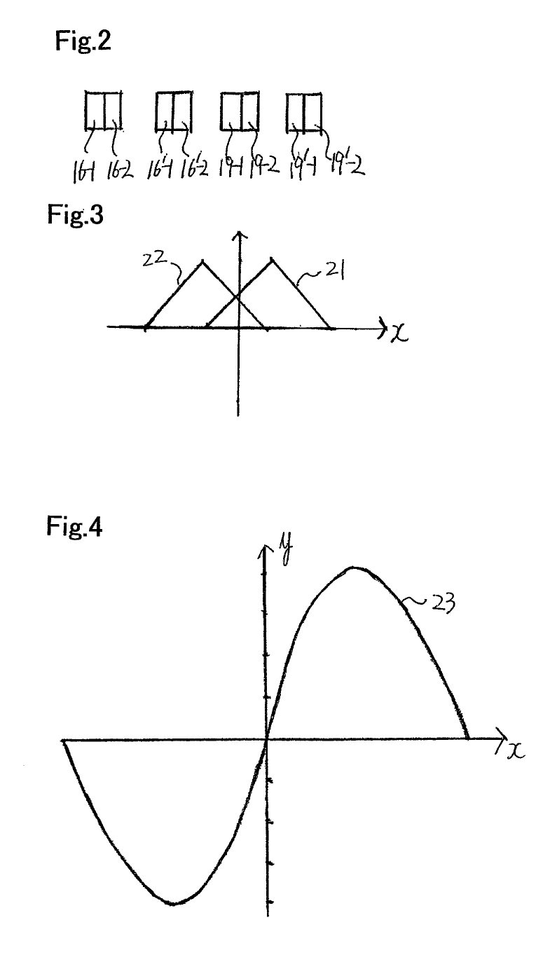

Every photo-detecting surface of said photo-detectors 16, 16′, 19, and 19′ is divided in halves as shown by (16-1, 16-2), (16′-1, 16′-2), (19-1, 19-2), (19′-1), and (19′-2) in FIG. 2 for the purpose of detecting by bisecting the returned light from light points on a line perpendicular to a recording track of the said optical disk 4 and passing the center of the reading focus spot.

Provided that the returned light from a point x on said optical disk 4 is focused on said photo detecting surfaces (16-1, 16-2), (16′-1, 16′-2), (19-1, 19-2), and (19′-1, 19′-2) and the light-intensity distribution is the shape of a cone with radius 1 and height 1, and provided that the position of said point x is equal to zero when said point x exists in a position on the line perpendicular to the recording track, passing the center of the reading focus spot on said optical disk 4. Then the detected quantity V of the returned light from said light point x on said optical disk 4, (which is computed by subtracting values of the quantity of light detected on photo-detecting surfaces (16-1, 16-2), (16′-1, 16′-2), (19-1, 19-2) or (19′-1, 19′-2)) can be calculated as half the volume of the non-common part of the two cones whose center cross sections form two isosceles triangles 21, and 22 with base 2 and height 1 as shown in FIG. 3. So V is shown as the following equation;

$V = 1 / 3 π ( 1 - x ) - 4 ( 1 - x ) {\int }_{0}^{1 - x} {\int }_{0}^{z} \sqrt{{( x + z )}^{2} - {( x + u )}^{2}} ⅆ x ⅆ u$

| | |
|---|---|
| x = 0.050 | V ˜ 0.10 |
| x = 0.100 | V ˜ 0.18 |
| x = 0.150 | V ˜ 0.25 |
| x = 0.200 | V ˜ 0.30 |
| x = 0.250 | V ˜ 0.35 |
| x = 0.300 | V ˜ 0.38 |
| x = 0.350 | V ˜ 0.41 |
| x = 0.400 | V ˜ 0.42 |
| x = 0.415 | V ˜ 0.42 |
| x = 0.425 | V ˜ 0.42 |
| x = 0.435 | V ˜ 0.42 |
| x = 0.450 | V ˜ 0.42 |
| x = 0.475 | V ˜ 0.41 |
| x = 0.500 | V ˜ 0.41 |
| x = 0.550 | V ˜ 0.39 |
| x = 0.600 | V ˜ 0.36 |
| x = 0.650 | V ˜ 0.33 |
| x = 0.700 | V ˜ 0.29 |
| x = 0.750 | V ˜ 0.25 |
| x = 0.800 | V ˜ 0.20 |
| x = 0.850 | V ˜ 0.16 |
| x = 0.900 | V ˜ 0.10 |
| x = 0.950 | V ˜ 0.05 |

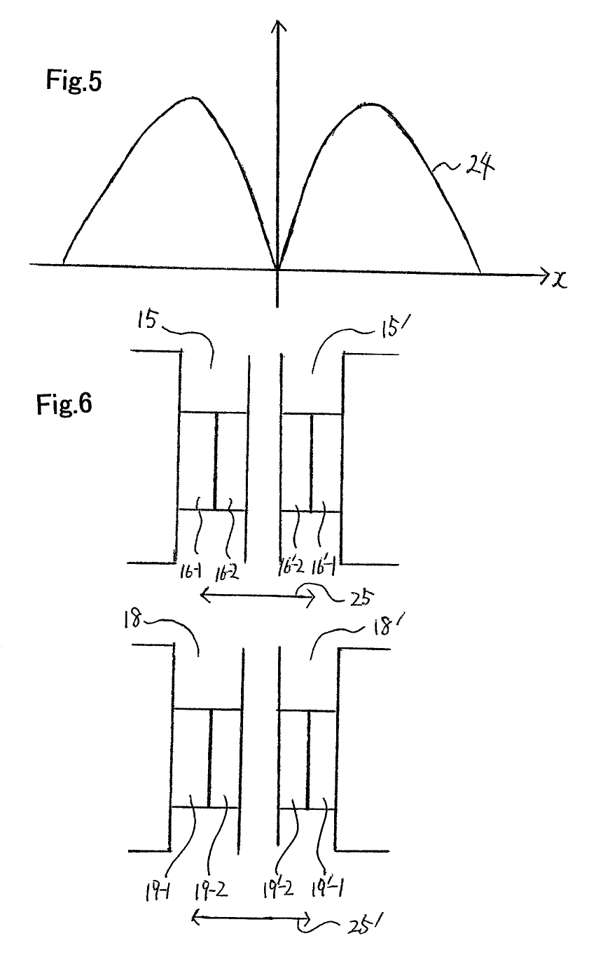

When several light points exist on either side of the center line of said reading focus spot on said optical disk 4 perpendicular to the recording track, the difference in the detected quantities of every said photo-detecting surface (16-1, 16-2), (16′-1, 16′-2), (19-1, 19-2), or (19′-1, 19′-2) is computed as the absolute value of the sum of each numerical value via the graph 23 in FIG. 4. Therefore the signal obtained from a recorded round-mark presents an extreme high-frequency distribution with two peaks as shown in graph 24 in FIG. 5.

Focusing of radiated light beam on said optical disk 4 is performed by equalizing the magnitude of the photo-detecting quantities of said photo detectors 16, 19; that of said photo detector 16 equals that of said photo-detecting surface (16-1) plus that of said photo-detecting surface (16-2); that of said photo-detector 19 equals that of said photo-detecting surface (19-1) plus that of said photo-detecting surface (19-2).

Said device for tracking 9 uses a conventional two-divided photo detector.

Without vibration scanning of the said reading focus spot, the center position of the focus spot is guided to the center of the aimed land by means of said tracking light deflector 5 adjusted with said device for tracking 9.

With vertical-vibration scanning using light deflector 6, the said reading focus spot switches between two adjacent recording tracks. Using said tracking light deflector 5 adjusted with said device for tracking 9 so that the both ends of the vibration will always cover the center of said aimed lands in adjacent tracks.

FIG. 6 shows the front view of an arrangement of said photo-detecting surfaces (16-1, 16-2), (16′-1, 16′-2), (19-1, 19-2), and (19′-1, 19′-2) and said linear slits 15, 15′, 18, and 18′.

The said light beams 12 and 13 are high-frequency-vibration scanned in the direction of the respective arrow marks 25, and 25′ by said light deflector 20.

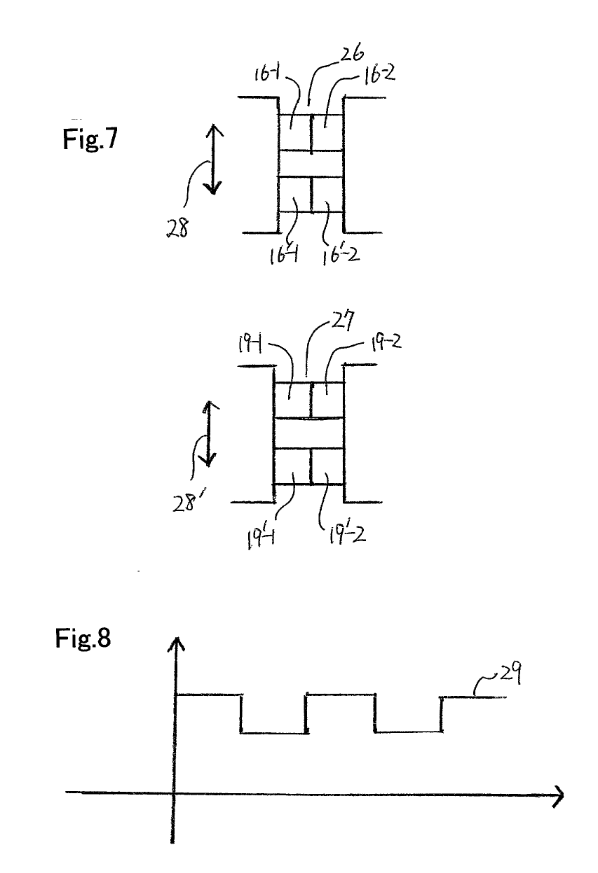

FIG. 7 shows the front view of an arrangement of said photo-detecting surfaces (16-1, 16-2), (16′-1, 16′-2), (19-1, 19-2), and (19′-1, 19′-2) and the linear slits 26 and 27 in another embodiment.

The said light beam 12, and 13 are then high-frequency-vibration scanned in the direction of the respective arrow marks 28, and 28′ by light deflector 20. A graph 29 in FIG. 8 shows the applied voltage to the said light deflector 6, and 20 utilizing the electro-optical effect, with the transverse and longitudinal axis indicating time and voltages respectively. It takes an extremely short period of time for the said reading focus spot and the focus spots of said light beams 12, and 13 to pass through the two adjacent recording tracks and the said divided photo-detecting surfaces (16-1, 16-2), (16′-1, 16′-2), (19-1, 19-2), and (19′-1, 19′-2) respectively.

So the photo-detected quantity on each of the said photo-detecting surfaces (16-1, 16-2), (16′-1, 16′-2), (19-1, 19-2), and (19′-1, 19′-2) almost corresponds to that detected while said reading focus spot exists in each of the two adjacent recording tracks.

In the embodiment in FIG. 6, although the difference in quantity detected by the two halves of the photo-detector increases slightly, while said focus spots deflected by said light deflector 20 pass through said photo-detecting surfaces 16-2, 16′-2, 19-2, and 19′-2, its value is almost a constant. This does not influence the measurement accuracy of the center position of the recorded round-marks and the deflective angle is minimal.

In the embodiment in FIG. 7, since said focus spots of said light beams 12, and 13 deflected by said light deflector 20 pass through the lines dividing said photo-detecting surfaces (16-1, 16-2), (16′-1, 16′-2), (19-1, 19-2), and (19′-1, 19′-2) into two, the said embodiment in FIG. 7 does not have the problem that was demonstrated with the embodiment in FIG. 6.

However, it is necessary to make the deflective distance of said focus spots of said light beams 12, and 13 deflected by said light deflector 20 longer than that generated by the deflective angle of the reading light beam irradiated on said optical disk 4 performed with said tracking light deflector 5.

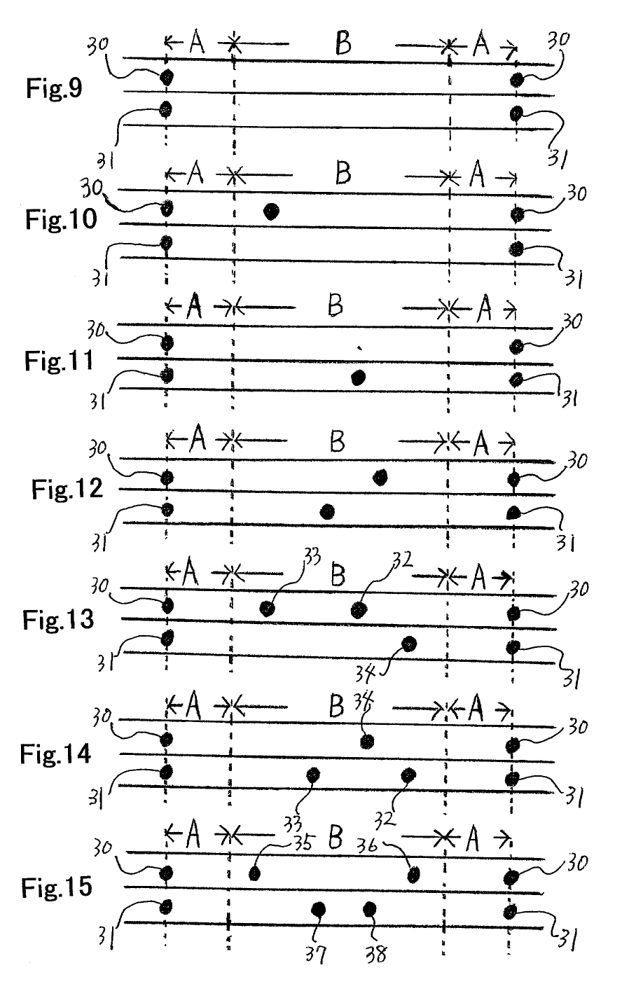

The optical disk recording and reading method in this invention forms two standard marks, 30, and 31 on two respective adjacent recording tracks, aligned in a direction perpendicular to the recording track as shown in FIG. 9. The area within said standard marks 30, and 31 and the next set of standard marks 30, and 31 on the same tracks is treated as a unit area for recording and reading.

If the minimal distance capable of reading between the center position of said standard marks 30, and 31 and that of said recorded round-marks is A, and the range of the center position capable of recording said recorded round-marks is B (B>2A). Then information is recorded within width B on two adjacent recording tracks, which is within the said unit for recording and reading. The information is written on to the disk using a combination of variables including; the distance between said recorded round marks on the recording track and each of the corresponding said standard marks 30, 31 on the same track; how many said recorded round-marks exist and on which recording track they exist in. In all cases, the center of two recorded round-marks on the two adjacent recording tracks cannot be aligned together on the same path perpendicular to the direction of recording tracks.

When information is read from recorded optical disk 4, the two marks that exist on two adjacent recording tracks aligned in a direction perpendicular to the recording track are determined. These two marks are said to be the two standard marks 30, 31. The recorded round marks are investigated to determine which side of the two recording tracks they exist on and what distance they are from their respective standard marks in the range between said two standard marks 30, 31 and the next two standard marks 30, and 31.

The optical disk recording and reading method in this invention makes said reading light beam high-vibration scan in a direction perpendicular to the recording track, so it is possible to write round-marks anywhere on the two recording tracks and accurately read said round-marks and said two standard marks 30, and 31 on the two recording tracks.

This method of recording and reading an optical disk requires higher precision in the reading of the recorded marks than a conventional optical disk, because a miss-reading of one recorded mark has a great influence on the reading of the recorded information on said optical disk 4. However, the recording and reading method of an optical disk in this invention exhibits a high-frequency two-peak wave form displaying the change in the photo-detecting quantity for said recorded round marks as shown in FIG. 5. So noises can be easily separated by extracting the extremely high frequency components from the detected signal, because each of the said recorded round-marks has a constant extremely high frequency.

Additionally this method detects the center position of said recorded round-marks and reads them by moving the reading focus spot only a short distance in the direction of the recording track as shown in FIG. 5. Said unit for recording and reading is shown in FIG. 9. When only one recorded round-mark exists in the said unit for recording and reading in FIGS. 10, and 11, it can move within the range 2B and has positional information of the amount 2N within the range 2B capable of recording and reading. When only one recorded round-mark exists on each of two recording tracks in said unit for recording and reading in FIG. 12, these two recorded round-marks have total positional information of the amount N² within the range of recording and reading.

When only two recorded round-marks 32, and 33 exist on one recording track and only one recorded round-mark 34 exists on the other recording track in said unit for recording and reading in FIGS. 13, and 14, the minimal distance capable of distinguishing said recorded round-mark 32 from said recorded round mark 33 is A. At this time, when the locations of recorded round-marks 33, and 34 are fixed, the range within which the center position of said recorded round-mark 32 can be placed is more than B−2A. Therefore, the range B within said unit for recording and reading has positional information of the amount more than (B−2A)N³/B capable of recording and reading. When two recorded round-marks 35, 36 and two recorded round-marks 37, 38 exist on their respective recording track in said unit for recording and reading in FIG. 15, the center position of said recorded round-mark 35, 37 can be placed in the range B, and at this time the center position of said recorded round-marks 36, 38 can be placed in the range more than B−2A

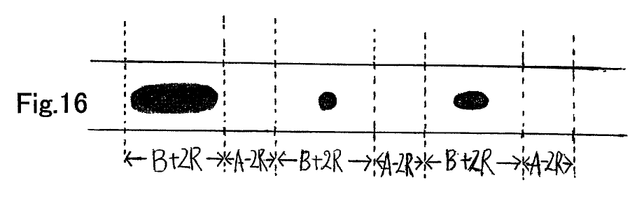

Therefore the range B within said unit for recording and reading has positional information of an amount more than (B−2A)²N⁴/2B². If the minimal recorded mark in a mark-edge recording method and the said recorded round-mark have the same radius R (See FIG. 16 explaining a mark-edge recording method) and the range capable of recording every recorded mark is B+2R and the distance across the recorded mark capable of recording is B. If the minimal distance between the ranges capable of recording is C, C is equal to A−2R provided that the precision of the conventional mark-edge recording method in recording and reading is comparable to the precision of the recording and reading method of this invention. The conventional mark-edge recording of optical disks, which uses positional information for the distance across a recorded mark, can record and read positional information of the amount 2N in the range C+B+2R or A+B on two reading tracks.

Therefore, it can record and read positional information of the amount (2A+B)2N/A+B in the range 2A+B on two recording tracks. In contrast, the recording and reading method of an optical disk in this invention can record and read positional information of this amount more than 2N+N²+(B−2A)N³/B+(B−2A)²N⁴/2B²+α in the range 2A+B on two recording tracks, (α>0). It is possible for the recording and reading method of optical disks in this invention to have a capacity to record and read very large volumes of information. The fluctuation of the focusing spot on the photo-detecting surfaces (16-1, 16-2), (16′-1, 16′-2), (19-1, 19-2), and (19′-1, 19′-2) owing to the tilting of said optical disk 4 is minimal because of the precise focusing of the reading light beam on optical disk 4. Utilizing this method of recording and reading optical disks, we can read recorded marks having a phase difference or polar Kerr effect, with the installation of bisected phase plate generating z phase difference close to each of said linear slits 15, 15′, 18, 18′, 26, and 27 and detect zero diffraction light from the before mentioned bisected phase plate.

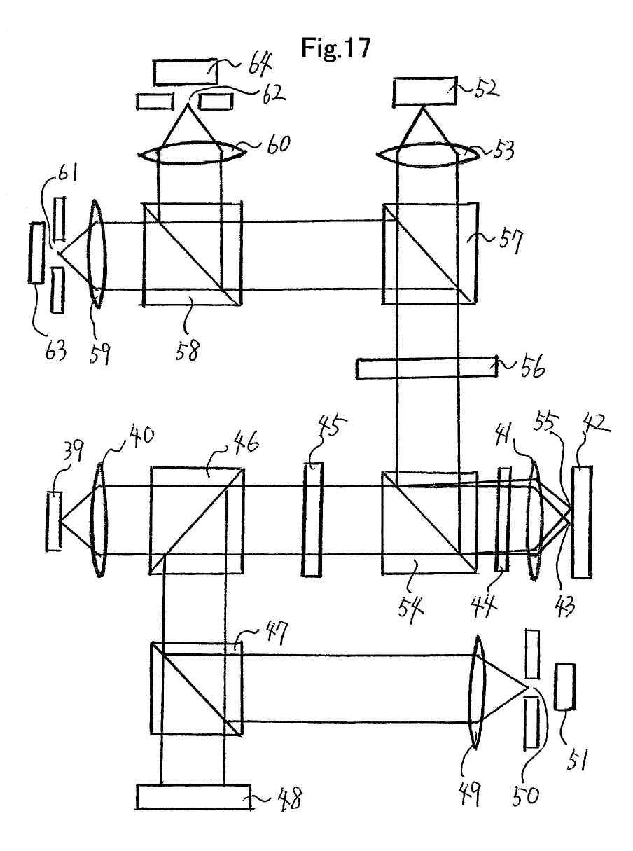

The other embodiment of the present invention is explained hereinafter referring to Figures. In FIG. 17, the laser beam emitted by a semiconductor laser source 39 is turned into parallel light by a coupling lens 40 and is focused on an optical disk 42 as a focus spot 43 by an objective 41. Tracking is performed by a light deflector 44. When the recorded information on the said optical disk 42 is read, the returned light from said focus spot 43 focused on said optical disk 42 passing back through the said objective 41, and said light deflector 44, and a quarter wave-length plate 45 and is separated by a polarization beam splitter 46, and then is split into two by a polarization beam splitter 47. One light beam is guided to a device for tracking 48 and the other light beam is focused on a linear slit 50 through an objective 49, and then is detected by a photo detector 51. Then the laser beam emitted by the other semiconductor laser source 52 is turned into parallel light by a coupling lens 53, and is deflected from its course by a polarization beam splitter 54 installed between said light deflector 44 and said quarter wave-length plate 45, and passes through said light deflector 44 and then is focused on the next track as a focus spot 55.

At this time, since the planes of polarization of the laser beams emitted by the semiconductor laser sources 39, and 52 are set to cross at a right angle with each other after they pass through their respective quarter wave-length plates 45, and 56, the reflected light from said focus spot 55 on said optical disk 42 passes through said objective 41, said light deflector 44, said polarization beam splitter 54, said quarter wave-length plate 56, and a polarization beam splitter 57, which splits it into two and focuses in linear slits 61, and 62 by objectives 59, and 60, and then is detected by photo detector 63, and 64, respectively. Consequently, it is possible for the two light beams from the said semiconductor laser sources 39, and 52 to focus on respective said focus spots 43, and 55 at the same time. The adjustment of the distance between said focus spots 43, and 55 is performed by using the angle between said polarization beam splitter 54 and the optical axis, which is simply achieved.

A simple bisected photo detector meets the requirements of said photo detector 51, 63, and 64. A conventional tracking method meets this embodiment's requirements. Alternately switching said semiconductor laser sources 39, and 52 on and off enables a more perfect system for discriminating the return light from the said focus spot 43 and from the said focus spot 55 than without switching. Since this method does not adopt a light deflector utilizing the electro-optical effect, the optical disk equipment exploiting this embodiment can be provided at a lower price and have a lighter ‘light pick-up’ than the previous embodiment. The optical disk recording and reading method in this invention can read at high speed because it reads two recording tracks at the same time. The Compact Disk using the method in this invention has relatively large round-marks, which are simply formed, and can represent a larger mass of information. While a few embodiments of the invention have been illustrated and described in detail, it is particularly understood that the invention is not limited thereto or thereby.

What is claimed is:

1. A recording and reading method of an optical disk comprising; positional information of recorded marks within a unit area for recording and reading that includes several recording tracks.

2. Said recording and reading method of claim 1, wherein standard marks are set in the said unit area for recording and reading that includes several recording tracks and where recorded marks have positional information shown by which recording track in the unit area for recording and reading said recorded marks exist in and by the distance said recorded marks are from said standard marks on the same respective track.

3. Said recording and reading method of claim 1, wherein said two standard marks are set on two adjacent respective recording tracks, aligned in a direction perpendicular to said recording tracks and said recorded marks are not recorded on two adjacent recording tracks while aligned in a direction perpendicular to said recording tracks.

4. Said recording and reading method of claim 1, wherein returned light from said optical disk is detected as two halves from the light points on a line that passes the center of the reading focus spot on said optical disk and is perpendicular to a recording track of the said optical disk.

5. Said recording and reading method of claim 1, wherein the planes of polarization of the laser beams emitted by two semiconductor laser sources are set to cross at a right angle with each other after said laser beams pass through two respective quarter wave-length plates.
